(19) United States
(12) Patent Application Publication
(10) Pub. No.: US 2023/0002704 A1
(43) Pub. Date: Jan. 5, 2023

(54) BLOOMING EFFECT USING SOLUBLE LAUNDRY SHEETS

(71) Applicant: Henkel AG & Co. KGaA, Duesseldorf (DE)

(72) Inventors: Andreas BAUER, Kaarst (DE); Frank JANSSEN, Hagen (DE); David MATULLA, Hilden (DE); Andreas GERIGK, Erkelenz (DE); Nadine BLUHM, Duesseldorf (DE)

(21) Appl. No.: 17/844,762

(22) Filed: Jun. 21, 2022

(30) Foreign Application Priority Data
Jun. 22, 2021 (DE) 10 2021 116 100.2

(51) Int. Cl. C11D 3/28; C11D 11/00; C11D 17/04; C11D 3/50; C11D 3/37; C11D 3/22; C11D 3/16; C11D 1/83

(52) U.S. Cl. CPC C11D 3/28; C11D 11/0017; C11D 17/044; C11D 3/505; C11D 3/3753; C11D 3/222; C11D 3/162; C11D 1/83

(57) ABSTRACT

Washing and/or care articles may include a substrate containing polyvinyl alcohol and starch and one or more perfume compositions comprising fragrance precursor compounds. Furthermore, such articles may be used for washing, cleaning and/or care purposes, such as for textiles. A method for washing, caring for or conditioning textiles using such an article is also disclosed.

### CROSS-REFERENCE TO RELATED APPLICATIONS

The present patent application claims priority, according to 35 U.S.C. § 119, from German Patent Application No. 10 2021 116 100.2 filed on Jun. 22, 2021, the entire disclosure of which is incorporated herein by reference.

### TECHNICAL FIELD

The present disclosure relates to washing and/or care articles which comprise a substrate containing polyvinyl alcohol and starch and at least one perfume composition containing fragrance precursor compounds. Furthermore, the disclosure relates to the use of such articles for washing, cleaning and/or care purposes, preferably for washing, caring for or conditioning textiles, and a method for washing, caring for or conditioning textiles using such an article.

### BACKGROUND

Although consumers of textile washing agents and textile care agents pay special attention to the respective product having a sufficient cleaning and/or care effect on the textiles to be washed, the demand for mono-dose washing agents, i.e. washing agents which are available in a unit dosage and are correspondingly easy to dose, is increasing at the same time. Commercial administration forms of such mono-dose washing agents are so-called “laundry caps (capsules)” and “laundry sheets.” However, these two administration forms each have different disadvantages or do not meet the requirements placed on them in different ways. Although the cleaning performance of washing agent caps is generally satisfactory, they often only partially dissolve in the washing liquor, which leads to residues of the shell material both in the washing machine and on clothing washed with the caps. Because water-soluble washing agent sheets are water-free, they are sustainable, logistically uncomplicated and, more importantly, easy to use for consumers.

In addition to the handling behavior of a particular washing or cleaning agent product, however, visual and olfactory aesthetics are still important criteria according to which consumers select the products and, if they like them, buy the products again. In order to be able to generate an appealing scent profile, it is first important that the respective perfume compositions are formulated in a stable manner, i.e. in particular that they remain stable even after the product has been stored fora long period of time and thus remain both perceptible and appealing in terms of odor. In addition to fragrancing the objects to be cleaned, such as dirty laundry or other textiles, but also hard surfaces, the odor profile of the product itself is also critically evaluated by the consumer, both before and during use. In particular in the case of manual cleaning, such as the manual cleaning of textile surfaces or hard surfaces, such as crockery and cutlery, a blooming fragrance profile which develops in the course of the cleaning process is perceived as pleasant.

Consequently, there is a continuing need for laundry and cleaning products which meet the aforementioned consumer requirements.

### SUMMARY

This problem is solved by the use of certain fragrance precursor substances, so-called “precursors,” in sheet-shaped textile washing and care agents (“laundry sheets”), because, as has surprisingly been found, the substrate materials are able to protect and stabilize the precursor-containing perfume compositions over a longer period of time, i.e. during product storage, for example. In addition, this combination according to the invention leads to an appealing “blooming effect”, i.e. a “blooming” (intensification) of the fragrance profile in the course of product use.

A first subject matter of the present invention is therefore a washing and/or care article for textiles, comprising a substrate and at least one perfume composition, characterized in that the substrate comprises polyvinyl alcohol and starch and the perfume composition comprises at least one free fragrance and at least one fragrance precursor compound.

In a further aspect, the invention relates to the use of such a washing and/or care article for washing, cleaning and/or care purposes, preferably for washing, caring for or conditioning textiles.

In a final aspect, the present invention also relates to a method for washing, caring for or conditioning textiles, characterized in that a washing and/or care article as described herein is used in at least one method step.

These and other aspects, features, and advantages of the invention will become apparent to a person skilled in the art through the study of the following detailed description and claims. Any feature from one aspect of the invention can be used in any other aspect of the invention.

The term “textile treatment agent” as used herein refers to an agent which is used to treat textiles and causes a change in at least one property of the textile, selected from chemical, physical or aesthetic properties, after the treatment has ended. In the context of the present invention, the constituents of a textile treatment agent can in principle be selected and adjusted in such a way that the agent has the desired treatment properties, for example textile cleaning, care, conditioning and/or color protection properties.

In the context of the present invention, the term “conditioning” means imparting a desired property, for example, in relation to textiles, a pleasant feel, crease resistance or low static charge. Accordingly, a “textile conditioning composition” as used herein is a composition which, when used in textile washing and/or care processes, is to impart a pleasant feel, wrinkle resistance or reduced static charge to the treated fabric.

The subject matter of the invention includes all conceivable textile washing and/or care methods, on a commercial scale, in the washing machine or in the case of hand washing. These include, for example, washing and cleaning methods and uses for the cleaning, care and/or conditioning, and pre- and/or post-treatment of all types of textiles, such as clothing, carpets and textile furniture surfaces.

### DETAILED DESCRIPTION

“At least one” as used herein includes, but is not limited to, 1, 2, 3, 4, 5, 6, and more. In relation to an ingredient, the expression refers to the type of ingredient and not to the absolute number of molecules. “At least one surfactant” thus means, for example, at least one type of surfactant, i.e. one type of surfactant or a mixture of a plurality of different surfactants can be meant. Together with weight specifications, the expression relates to all compounds of the type indicated that are contained in the composition/mixture; i.e., the composition does not contain any other compounds of this type beyond the indicated amount of the corresponding compounds.

Unless indicated otherwise, all percentages are indicated in terms of wt. %. Numerical ranges which are indicated in the format “from x to y” also include the stated values. If several preferred numerical ranges are indicated in this format, it is readily understood that all ranges which result from the combination of the various endpoints are also included.

“Approximately” or “approx.” as used herein in connection with a numerical value relates to the numerical value ±10%, preferably ±5%.

When reference is made herein to molar masses, this information always refers to the number-average molar mass Mₙ, unless explicitly indicated otherwise. The number-average molar mass can, for example, be determined by gel permeation chromatography (GPC) according to DIN 55672-1:2007-08 with THF as the eluent. The weight-average molar mass M_{w} can also be determined by means of GPC, as described for Mₙ.

Whenever alkaline earth metals are mentioned in the following as counterions for monovalent anions, this means that the alkaline earth metal is naturally only present in half the amount of substance—sufficient to balance the charge—of the anion.

“Phosphate-free” and “phosphonate-free,” as used herein, mean that the composition in question is substantially free of phosphates or phosphonates, i.e., in particular contains phosphates or phosphonates in amounts of less than 0.1 wt. %, preferably less than 0.01 wt. %, based on the particular composition.

A first subject matter of the present invention is a washing and/or care article for textiles, comprising a substrate and at least one perfume composition, the substrate comprising polyvinyl alcohol and starch and the perfume composition comprising at least one free fragrance and at least one fragrance precursor compound.

The washing and/or care article for textiles according to the invention is generally an article comprising a substrate which preferably has a planar shape. In the context of the present invention, “planar” refers to a planar extension, or shape, for example the shape of a cloth or a sheet. Thus, in some embodiments, a washing and/or care article according to the invention is in the form of a sheet, a non-woven fabric, a knitted fabric, a woven fabric or a film. The dimensions of the substrate are preferably selected to be user-friendly, for example such that the article can preferably be used as a unit dosage in textile washing and/or care methods. In some embodiments, the article is a textile article, for example woven, non-woven, knitted or braided, preferably non-woven, in the form of a cloth. In various other embodiments, the planar substrate is a film.

According to the invention, the substrate material of the article is in particular a water-soluble substrate material.

In the context of the present invention, “water-soluble” refers to a material which not only insignificantly swells, dissolves and/or decomposes upon contact with water, for example upon contact with a washing liquor, the structure of which material disintegrates or the constituents of which at least partially solubilize, preferably substantially solubilize, most preferably completely solubilize and/or become suspended upon contact with water.

According to the invention, the substrate comprises polyvinyl alcohol and starch. Correspondingly, the substrate can be in the form of a water-soluble film, for example, i.e. in the form of a PVA-containing film.

In various embodiments, the proportion of polyvinyl alcohol is approximately 1 to 80 wt. %, more preferably approximately 10 to 30 wt. %, for example approximately 10, 11, 12, 13, 14, 15, 16, 17, 18, 19, 20, 21, 22, 23, 24, 25, 26, 27, 28, 29 or 30 wt. %, in each case based on the total weight of the substrate.

Starch which is suitable in the context of the present invention includes, but is not limited to, corn starch, amyl corn starch, potato starch, rice starch, pea starch, cassava starch, wheat starch, waxy starch, and starch degradation products such as dextrins. In various embodiments, a proportion of starch of approximately 1 to 80 wt. %, more preferably approximately 10 to 50 wt. %, for example approximately 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50 wt. %, is provided, in each case based on the total weight of the substrate. Mixtures of the aforementioned types of starch, including their degradation products, are also possible, with the aforementioned amount specifications then relating to the total mass of the respective types of starch used. In various embodiments, the substrate accordingly comprises one or more types of starch selected from the group consisting of corn starch, potato starch, rice starch, pea starch, cassava starch, wheat starch, waxy starch and dextrins.

In various embodiments, the substrate comprises other components. Materials which are suitable in this context, from which, for example, fibers for the production of water-soluble substrates can consist, are known in principle in the prior art and include materials made of polymers of natural, synthetic and semi-synthetic origin, for example and not limited to, polyamides, polylactides, proteins, alginate, chitosan, galactans, gum arabic and derivatives and copolymers thereof. In various embodiments, a water-soluble substrate comprises at least one further water-soluble polymer, preferably selected from the group consisting of polyamide, polylactide, protein, alginate, chitosan, galactan, gum arabic, agar and derivatives and copolymers thereof.

It may be preferable for the substrate to contain additional components, for example plasticizers such as dipropylene glycol, ethylene glycol, diethylene glycol, propylene glycol, glycerol, sorbitol, mannitol or mixtures thereof. In various embodiments it is preferable for the washing and/or care article to comprise glycerol, preferably in an amount of approximately 0.001 to 30 wt. %, more preferably approximately 0.1 to 20 wt. %, for example approximately 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.5, 3.0, 3.5, 4.0, 4.5, 5, 6, 7, 8, 9, 10, 11, 12, 13, 14, 15, 16, 17, 18, 19 or 20 wt. %, in each case based on the total weight of the washing and/or care article.

When the substrate comprises or consists of fibers, virtually any diameter or denier of a particular fiber can be used. Suitable fibers are, but are not limited to, approximately 1.0 to approximately 2.0 dtex, preferably approximately 1.2 to approximately 1.5 dtex, and/or approximately 30 to approximately 45 mm, preferably approximately 35 to approximately 42 mm. The substrate, for example in the form of a sheet, a non-woven fabric or the like, may be wet-laid or spun, depending on the length of the fibers. It is preferable for the fibers to have a length of from approximately 2 mm to 5 mm for wet-laid non-woven fabrics and from 30 mm to 50 mm for spun non-woven fabrics. In any of the embodiments described herein, all of the fibers may be in the form of a yarn.

The thickness of the preferably planar substrate is preferably from 0.62 mm to 1.5 mm, more preferably from 1.0 mm to 1.2 mm.

The article is preferably formed with a weight per unit area of 100-500 g/m², 100-400 g/m², 120-350 g/m² or 150-300 g/m², preferably approximately 250 g/m². These values apply to the article in its ready-to-use, i.e. dry form.

The dimensions of an article according to the invention that is cut to be ready for use, in particular in the form of a unit dosage, can have dimensions in the range of approximately 20-30 cm×10-20 cm, for example, such as approx. 25 cm×12 cm. However, it should be noted that, in principle, any dimension can be selected that appears advantageous for the intended use.

The purpose of the substrate is to provide a carrier or a matrix for the at least one perfume composition, as defined and described below, and preferably other active substances, as explained below, and also to provide a sufficient area over which the at least one perfume composition, and preferably other active substances, are accessible to the liquid in the bath or washing water in which the washing and/or care article for textiles is to be used. Although applications in automatic washing machines, such as front loaders or top loaders, are also possible, the preferred applications according to the invention are manual washing and cleaning methods, since the “blooming effect” of the washing and/or care sheets according to the invention is particularly advantageous in this case.

As has been shown, the mixture of starch and polyvinyl alcohol contained in the substrate can be loaded with a perfume composition containing at least one fragrance precursor compound, with the hydrolytically cleavable fragrance precursor compounds contained in the perfume being protected in this way over a longer period of time, i.e. in particular over the duration of product storage. The hydrolytic cleavage of the fragrance precursor compounds and thus the release of the pure fragrances during product use, i.e. when the article comes into contact with washing water, results in a “fragrance bloom”.

In addition, due to the low-water to water-free formulation of the article, a fragrancing property of the article that remains high-quality even over long periods of storage is ensured, which property is noticeable in improved fragrancing intensities on textiles treated with said article.

The at least one perfume composition, which according to the invention is a constituent of the washing and/or care article, is a mixture of perfumes and odorants also containing at least one fragrance precursor compound, a so-called precursor. Correspondingly, a perfume composition contained according to the invention is composed of at least one freely available fragrance or at least one mixture of free fragrances and also at least one fragrance precursor compound. In this context, the term “free” means that a corresponding perfume is not bound in the form of a fragrance precursor compound, as disclosed below.

Correspondingly, the at least one perfume composition contains at least one free fragrance as a constituent of the article according to the invention.

As fragrances, odorants or perfume oils, all substances and mixtures known for this purpose can be used. Within the meaning of this invention, the terms “odorant(s),” “fragrances” and “perfume oil(s)” are used synonymously. The terms refer, in particular, to all substances or mixtures thereof which are perceived by humans and animals as having an odor, in particular perceived by humans as having a pleasant odor.

Perfumes, perfume oils, or perfume oil constituents may be used as fragrance constituents. Perfume oils or fragrances may, according to the invention, be individual odorant compounds, such as synthetic products of the ester, ether, aldehyde, ketone, alcohol, and hydrocarbon types.

Fragrance compounds of the aldehyde type are, for example, adoxal (2,6,10-trimethyl-9-undecenal), anisaldehyde (4-methoxybenzaldehyde), cymene (3-(4-isopropyl-phenyl)-2-methylpropanal), ethylvanillin, Florhydral (3-(3-isopropylphenyl)butanal), helional (3-(3,4-methylenedioxyphenyl)-2-methylpropanal), heliotropin, hydroxycitronellal, lauraldehyde, Lyral (3- and 4-(4-hydroxy-4-methylpentyl)-3-cyclohexene-1-carboxaldehyde), methylnonylacetaldehyde, Lilial (3-(4-tert-butylphenyl)-2-methylpropanal), phenylacetaldehyde, undecylenealdehyde, vanillin, 2,6,10-trimethyl-9-undecenal, 3-dodecen-1-al, alpha-n-amylcinnamaldehyde, melonal (2,6-dimethyl-5-heptenal), 2,4-di-methyl-3-cyclohexene-1-carboxaldehyde (Triplal), 4-methoxybenzaldehyde, benzaldehyde, 3-(4-tert-butylphenyl)-propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]-decylidene-8)-butanal, octahydro-4,7-methane-1H-indenecarboxaldehyde, 3-ethoxy-4-hydroxybenzaldehyde, para-ethyl-alpha,alpha-dimethylhydrocinnamaldehyde, alpha-methyl-3,4-(methylenedioxy)-hydrocinnamaldehyde, 3,4-methylenedioxybenzaldehyde, alpha-n-hexylcinnamaldehyde, m-cymene-7-carboxaldehyde, alpha-methylphenylacetaldehyde, 7-hydroxy-3,7-dimethyloctanal, undecenal, 2,4,6-trimethyl-3-cyclohexene-1-carboxaldehyde, 4-(3)(4-methyl-3-pentenyl)-3-cyclohexene carboxaldehyde, 1-dodecanal, 2,4-dimethylcyclohexene-3-carboxaldehyde, 4-(4-hydroxy-4-methylpentyl)-3-cyclohexene-1-carboxaldehyde, 7-methoxy-3,7-dimethyloctan-1-al, 2-methyl-undecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanindan-1- or 2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyl-octanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanindan-1-carboxaldehyde, 2-methyloctanal, alpha-methyl-4-(1-methylethyl)benzeneacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methylnonylacetaldehyde, hexanal and trans-2-hexenal.

Fragrance compounds of the ketone type are, for example, methyl-beta-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyldihydrojasmonate, menthone, carvone, camphor, Koavone (3,4,5,6,6-pentamethylhept-3-en-2-one), fenchone, alpha-ionone, beta-ionone, gamma-methyl-ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)-ethan-1-one (and isomers)), methyl cedrenyl ketone, acetophenone, methyl acetophenone, para-methoxy acetophenone, methyl beta-naphthyl ketone, benzyl acetone, benzophenone, para-hydroxyphenyl butanone, celery ketone (3-methyl-5-propyl-2-cyclohexenone), 6-isopropyldecahydro-2-naphthone, dimethyloctenone, frescomenthe (2-butan-2-yl-cyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6(2)-yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)-indanone, 4-damascol, Dulcinyl (4-(1,3-benzodioxol-5-yl)butan-2-one), Hexalone (1-(2,6,6-trimethyl-2-cyclohexen-1-yl)-1,6-heptadien-3-one), Isocyclemone E (2-acetonaphthone-1,2,3,4,5,6,7,8-octahydro-2,3,8,8-tetramethyl), methyl nonylketone, methylcyclocitrone, methyl lavender ketone, Orivone (4-tert-amyl-cyclohexanone), 4-tert-butylcyclohexanone, Delphone (2-pentyl-cyclopentanone), muscone (CAS 541-91-3), Neobutenone (1-(5,5-dimethyl-1-cyclohexenyl)pent-4-en-1-one), plicatone (CAS 41724-19-0), Veloutone (2,2,5-trimethyl-5-pentylcyclopentan-1-one), 2,4,4,7-tetramethyl-oct-6-en-3-one and tetrameran (6,10-dimethylundecen-2-one).

Fragrance compounds of the alcohol type are, for example, 10-undecen-1-ol, 2,6-dimethylheptan-2-ol, 2-methylbutanol, 2-methylpentanol, 2-phenoxyethanol, 2-phenylpropanol, 2-tert-butycyclohexanol, 3,5,5-trimethylcyclohexanol, 3-hexanol, 3-methyl-5-phenyl-pentanol, 3-octanol, 3-phenyl-propanol, 4-heptenol, 4-isopropylcyclohexanol, 4-tert-butycyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, β-terpineol, butyl salicylate, citronellol, cyclohexyl salicylate, decanol, di-hydromyrcenol, dimethylbenzylcarbinol, dimethylheptanol, dimethyloctanol, ethylsalicylate, ethylvanillin, eugenol, farnesol, geraniol, heptanol, hexylsalicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylate, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

Fragrance compounds of the ester type are e.g. benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmacyclate.

Ethers include, for example, benzyl ethyl ether and Ambroxan. Hydrocarbons mainly include terpenes such as limonene and pinene.

Preferably, mixtures of different fragrances are used, which together produce an appealing fragrance note. Such a mixture of fragrances may also be referred to as perfume or perfume oil. Perfume oils of this kind may also contain natural fragrance mixtures, such as those obtainable from plant sources.

Fragrances of plant origin include essential oils, such as angelica root oil, aniseed oil, arnica blossom oil, basil oil, bay oil, champaca blossom oil, citrus oil, abies alba oil, abies alba cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, labdanum oil, lavender oil, lemon grass oil, lime blossom oil, lime oil, mandarin oil, melissa oil, mint oil, musk seed oil, muscatel oil, myrrh oil, clove oil, neroli oil, niaouli oil, olibanum oil, orange blossom oil, orange peel oil, oregano oil, palmarosa oil, patchouli oil, balsam Peru oil, petitgrain oil, pepper oil, peppermint oil, allspice oil, pine oil, rose oil, rosemary oil, sage oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil, and ambrettolide, Ambroxan, alpha-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmine, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl beta-naphthyl ketone, methyl n-nonylacetaldehyde, methyl n-nonyl ketone, muscone, beta-naphthol ethyl ether, beta-naphthol methyl ether, nerol, n-nonylaldehyde, nonyl alcohol, n-octylaldehyde, p-oxy-acetophenone, pentadecanolide, beta-phenethyl alcohol, phenylacetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, gamma-undelactone, vanillin, veratraldehyde, cinnamaldehyde, cinnamyl alcohol, cinnamic acid, cinnamic acid ethyl ester, cinnamic acid benzyl ester, diphenyl oxide, limonene, linalool, linalyl acetate and propionate, melusate, menthol, menthone, methyl-n-heptenone, pinene, phenylacetaldehyde, terpinyl acetate, citral, citronellal and mixtures thereof.

Mixtures of said substances may also be used.

If it is to be perceptible, an odorant must be volatile, with the molar mass, in addition to the nature of the functional groups and the structure of the chemical compound, also playing an important role. Therefore, most odorants have molar masses of up to approximately 200 daltons, while molar masses of 300 daltons and above are something of an exception. Due to the differing volatility of odorants, the odor of a perfume or fragrance composed of multiple odorants varies over the course of evaporation, the odor impressions being divided into “top note,” “middle note or body” and “end note or dry out.” Analogously to the description in the international patent publication WO 2016/200761 A2, the top, middle and end notes can be classified on the basis of their vapor pressure (determinable by means of the test methods described in WO 2016/200761) as follows:

Top note: vapor pressure at 25° C.: >0.0133 kPa

Middle note: vapor pressure at 25° C.: 0.0133 to 0.000133 kPa

End note: vapor pressure at 25° C.: <0.000133 kPa

Examples of adherent odorants which can be used within the scope of the present invention are essential oils such as angelica root oil, aniseed oil, arnica blossom oil, basil oil, bay oil, bergamot oil, champaca blossom oil, abies alba oil, abies alba cone oil, elemi oil, eucalyptus oil, fennel oil, spruce needle oil, galbanum oil, geranium oil, ginger grass oil, guaiac wood oil, gurjun balsam oil, helichrysum oil, ho oil, ginger oil, iris oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, lavender oil, lemon grass oil, lime oil, mandarin oil, melissa oil, musk seed oil, myrrh oil, clove oil, neroli oil, niaouli oil, olibanum oil, orange oil, oregano oil, palmarosa oil, patchouli oil, balsam Peru oil, petitgrain oil, pepper oil, peppermint oil, allspice oil, pine oil, rose oil, rosemary oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil, and cypress oil.

Higher-boiling or solid odorants of natural or synthetic origin include, for example: ambrettolide, α-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmone, camphor, carvacrol, carvone, p-cresol methyl ether, coumarin, p-methoxyacetophenone, methyl n-amyl ketone, methylanthranilic acid methyl ester, p-methylacetophenone, methylchavicol, p-methylquinoline, methyl-β-naphthyl ketone, methyl n-nonyl acetaldehyde, methyl n-nonyl ketone, muscone, β-naphthol ethyl ether, β-naphthol methyl ether, nerol, nitrobenzene, n-nonyl aldehyde, nonyl alcohol, n-octylaldehyde, p-oxyacetophenone, pentadecanolide, β-phenethyl alcohol, phenylacetaldehyde dimethyl acetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, γ-undelactone, vanillin, veratraldehyde, cinnamaldehyde, cinnamyl alcohol, cinnamic acid, cinnamic acid ethyl ester and cinnamic acid benzyl ester.

More volatile odorants include in particular lower-boiling odorants of natural or synthetic origin, which may be used alone or in mixtures. Examples of more volatile odorants are alkyl isothiocyanates (alkyl mustard oils), butanedione, limonene, linalool, linayl acetate and propionate, menthol, menthone, methyl-n-heptenone, phellandrene, phenylacetaldehyde, terpinyl acetate, citral and citronellal.

Odorant compounds of the aldehyde type that can preferably be used are hydroxycitronellal (CAS 107-75-5), Helional (CAS 1205-17-0), citral (5392-40-5), bourgeonal (18127-01-0), Triplal (CAS 27939-60-2), Ligustral (CAS 68039-48-5), vertocitral (CAS 68039-49-6), Florhydral (CAS 125109-85-5), citronellal (CAS 106-23-0) and citronellyloxyacetaldehyde (CAS 7492-67-3).

In addition to or as an alternative to the above-mentioned odorants, it is also possible to use the odorants described in WO 2016/200761 A2, in particular the odorants mentioned in Tables 1, 2 and 3, and the modulators listed in Tables 4a and 4b. The whole of this publication is incorporated herein by way of reference.

A perfume oil can also be contained in the form of a perfume oil preparation and for example comprise at least one further active substance in oil form. Suitable active substances in oil form in this context are those which are suitable for washing, cleaning, care and/or finishing purposes, in particular
(a) textile care substances, such as preferably silicone oils, and/or
(b) skin care substances, such as preferably vitamin E, natural oils and/or cosmetic oils.

Skin care active substances are all active substances which give the skin a sensory and/or cosmetic advantage. Skin care active substances are preferably selected from the following substances:
a) waxes such as carnauba, spermaceti, beeswax, lanolin and/or derivatives thereof and others
b) hydrophobic plant extracts
c) hydrocarbons such as squalene and/or squalane
d) higher fatty acids, preferably those having at least 12 carbon atoms, for example lauric acid, stearic acid, behenic acid, myristic acid, palmitic acid, oleic acid, linoleic acid, linolenic acid, isostearic acid and/or polyunsaturated fatty acids and others
e) higher fatty alcohols, preferably those having at least 12 carbon atoms, for example lauryl alcohol, cetyl alcohol, stearyl alcohol, oleyl alcohol, behenyl alcohol, cholesterol and/or 2-hexadecanol and others
f) esters, preferably such as cetyloctanoate, lauryl lactate, myristyl lactate, cetyl lactate, isopropyl myristate, myristyl myristate, isopropyl palmitate, isopropyl adipate, butyl stearate, decyl oleate, cholesteryl isostearate, glycerol monostearate, glyceryl distearate, glycerol tristearate, alkyl lactate, alkyl citrate and/or alkyl tartrate and others
g) lipids such as cholesterol, ceramides and/or sucrose esters and others
h) vitamins such as vitamins A, C and E, vitamin alkyl esters, including vitamin C alkyl esters and others
i) sunscreens
j) phospholipids
k) derivatives of alpha hydroxy acids
l) germicides for cosmetic use, both synthetic such as salicylic acid and/or others and natural such as neem oil and/or others
m) silicones
n) natural oils, e.g., almond oil and mixtures of any of the components listed above.

According to the invention, the at least one perfume composition contains at least one fragrance precursor compound. Fragrance precursor compounds (“precursors”), which are suitable in the context of the present invention, are selected from the group of oxazolidine compounds, as disclosed in WO 2007/087977 A1, and silicic acid esters, as disclosed in WO00/14091 A1 and WO 01/68037 A2. Correspondingly, reference is expressly and explicitly made to the aforementioned documents and the fragrance precursor compounds disclosed therein. Of course, mixtures of the aforementioned fragrance precursor compounds are also possible.

Suitable fragrance precursor compounds from the group of oxazolidine compounds are in particular 1-aza-3,7-dioxabicyclo[3.3.0]octane compounds, i.e. bicyclic oxazolidine compounds which satisfy formula (I):

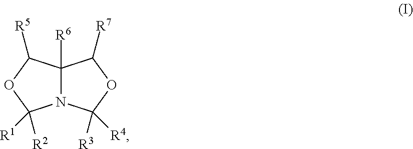

wherein
R¹ and R³ each represent, independently of one another, hydrogen or a group having 1 to 10 carbon atoms; and
R² and R⁴ each represent, independently of one another, groups having 1 to 25 carbon atoms; and
R⁵ and R⁷ each represent, independently of one another, hydrogen or a group having 1 to 6 carbon atoms; and
R⁶ represents hydrogen or a group having 1 to 8 carbon atoms, wherein
   one or more methyl groups, methylene groups, methine groups or quaternary carbon atoms of R¹ to R⁷ can each be substituted, independently of one another, with heteroatoms; and
   at least one of the structural fragments —CR¹R²— or —CR³R⁴— of general formula (I) originates from a fragrance aldehyde or fragrance ketone; and
   if one of the structural fragments —CR¹R²— or —CR³R⁴— originates from a fragrance ketone, R¹ and R² or R³ and R⁴ of this structural fragment can be wholly or partially an integral constituent of a ring.

The compounds of general formula (I) are obtained by reacting compounds of general formula (II)

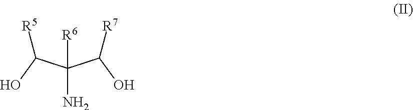

with compounds of the general formulas R¹—C(═O)—R² and R³—C(═O)—R⁴ for ring closure.

The compounds of general formula (II) are derived from 2-amino-1,3-propanediol. By preparing the bicyclic oxazolidines, it is possible to achieve a high degree of loading of the 2-amino-1,3-propanediols, so that it is possible to use small amounts of the 2-amino-1,3-propanediols. The scent impression can thus be extended even with small amounts of 2-amino-1,3-propanediols, which can lead to cost advantages, inter alia, and also prevents the entry of larger amounts of chemicals into corresponding consumer products.

It is also possible to use mixtures of singly and doubly closed compounds based on 2-amino-1,3-propanediols according to formulas (III) and (I). In this case, it is preferable to achieve a high degree of loading of the 2-amino-1,3-propanediols, so that preferably double-reacted 2-amino-1,3-propanediols of general formula (I) are used.

In a preferred embodiment of the invention, in the at least one bicyclic oxazolidine of general formula (I),
R¹ and R³ each represent, independently of one another, hydrogen or a group having 1 to 6 carbon atoms; and
R² and R⁴ each represent, independently of one another, a group having 2 to 17 carbon atoms; and
R⁵ and R⁷ each represent, independently of one another, hydrogen or a group having 1 to 4 carbon atoms; and
R⁶ represents hydrogen or a group having 1 to 6 carbon atoms.

In a further preferred embodiment of the invention, in the at least one bicyclic oxazolidine of general formula (I),
R¹ and R³ each represent, independently of one another, hydrogen or a group having 1 to 4 carbon atoms; and
R² and R⁴ each represent, independently of one another, a group having 4 to 14 carbon atoms; and
R⁵ and R⁷ each represent, independently of one another, hydrogen or a group having 1 to 4 carbon atoms; and
R⁶ represents hydrogen or a group having 1 to 4 carbon atoms.

In the most preferred embodiment of the invention, in the at least one bicyclic oxazolidine of general formula (I), R¹ to R⁴ are groups which originate from a fragrance aldehyde or fragrance ketone selected from the group of jasmones, the ionones, the damascones and damascenones, menthone, carvone, Iso E Super, methylheptenone, melonal, cymene, ethylvanillin, helional, hydroxycitronellal, Koavone, methyl nonyl acetaldehyde, phenylacetaldehyde, undecylenealdehyde, 3-dodecen-1-al, alpha-n-amylcinnamaldehyde, benzaldehyde, 3-(4-tert-butylphenyl)propanal, 2-methyl-3-(para-methoxyphenylpropanal), 2-methyl-4-(2,6,6-trimethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzyaldehyde, 2,4-dimethyl-3-cyclohexene-1-carboxyaldehyde, 2-methyl-3-(isopropylphenyl)propanal, decylaldehyde, 2,6-dimethyl-5-heptenal, alpha-n-hexylcinnamaldehyde, 7-hydroxy-3,7-dimethyloctanal, undecenal, 2,4,6-trimethyl-3-cyclohexene-1-carboxaldehyde, 1-dodecanal, 2,4-dimethylcyclohexene-3-carboxaldehyde, 4-(4-hydroxy-4-methylpentyl)-3-cyclohexene-1-carboxaldehyde, 2-methyl undecanal, 2-methyl decanal, 1-nonanal, 1-octanal, 2,6,10-trimethyl-5,9-undecadienal, 2-methyl-3-(4-tert-butyl)propanal, dihydrocinnamaldehyde, 3,7-dimethyloctan-1-al, 1-undecanal, 10-undecen-1-al, 4-hydroxy-3-methoxybenzaldehyde, trans-4-decenal, 2,6-nonadienal, para-tolylacetaldehyde, 3,7-dimethyl-2-methylene-6-octenal, 2-methyloctanal, alpha-methyl-4-(1-methylethyl)benzeneacetaldehyde, 2-methyl-3-phenyl-2-propen-1-al, 3,5,5-trimethylhexanal, 3-propylbicyclo[2.2.1]hept-5-ene-2-carbaldehyde, 9-decenal, 3-methyl-5-phenyl-1-pentanal, methyl nonylacetaldehyde, citral, 1-decanal, Florhydral, 2,4-dimethyl-3-cyclohexene-1-carboxaldehyde, heliotropine, or mixtures thereof.

In a further preferred embodiment of the invention, the perfume composition according to the invention, in addition to the 1-aza-3,7-dioxabicyclo[3.3.0]octane compound of general formula (I), additionally contains at least one compound of general formula (III)

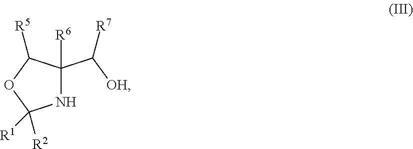

wherein R¹, R² and R⁵ to R⁷ of general formula (III) represent the same groups as R¹, R² and R⁵ to R⁷ of general formula (I).

Suitable fragrance precursor compounds from the group of silicic acid esters are in particular those of formula (IV):

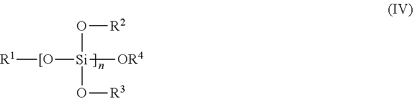

wherein R¹ and R⁴ are independently selected from the group consisting of straight-chain or branched, saturated or unsaturated, substituted or unsubstituted Cis hydrocarbon groups and fragrance alcohol groups, each R² and R³ is selected independently of one another from the group consisting of fragrance alcohol groups, and n takes values between 2 and 20.

The compounds mentioned can be prepared by simple transesterification of oligosilicic acid esters of lower alcohols with fragrance alcohols, wherein it is possible to use both individual fragrance alcohols and fragrance alcohol mixtures. Depending on the reaction time and reaction conditions, the lower alcohols are cleaved off and the fragrance alcohols are bound, with the alcohols being more easily exchanged along the Si—O—Si chain than the terminal alcohols. In this way it is possible to prepare oligomeric silicic acid esters in which R² and R³ are fragrance alcohol groups, while the terminal groups R¹ and R⁴ are still unreacted, i.e. represent groups of lower alcohols.

Oligosilicic acid esters of lower alcohols are commercially available, with methanol, ethanol, n-propanol, isopropanol, n-butanol, isobutanol and tert-butanol usually being used for esterification. The preparation of oligosilicic acid esters which have not been completely transesterified with fragrance alcohols leads to silicic acid esters of formula (IV), in which R¹ and R⁴ are selected independently of one another from the group consisting of methyl, ethyl, n-propyl, isopropyl, n-butyl, isobutyl and tert-butyl. Such compounds are preferred within the scope of the present invention.

If oligosilicic acid esters which have not been completely transesterified are prepared, R² and R³ are preferably selected from the group of fragrance alcohol groups. In the context of the silicic acid esters described herein, the term “fragrance alcohols” is understood to mean fragrances which have free hydroxyl groups which can be esterified, regardless of how the molecule is further structured. Thus, salicylic acid esters can also be used as fragrance alcohols. Preferred representatives can be named from the large group of fragrance alcohols, so that in the context of the present invention, in various embodiments, silicic acid esters are preferred in which each R² and R³ is selected independently of one another from the group of residues of the following fragrance alcohols: 10-undecen-1-ol, 2,6-dimethylheptan-2-ol, 2-methylbutanol, 2-methylpentanol, 2-phenoxyethanol, 2-phenylpropanol, 2-tert-butycyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol, 4-tert-butylcyclohexanol, 6,8-dimethyl-2-nonanol, 6-nonen-1-ol, 9-decen-1-ol, alpha-methylbenzyl alcohol, alpha terpineol, amyl salicylate, benzyl alcohol, benzyl salicylate, beta-terpineol, butyl salicylate, citronellol, cyclohexyl salicylate, decanol, dihydromyrcenol, dimethyl benzyl carbinol, dimethyl heptanol, dimethyl octanol, ethyl salicylate, ethylvanillin, eugenol, geraniol, heptanol, hexyl salicylate, isoborneol, isoeugenol, isopulegol, linalool, menthol, myrtenol, n-hexanol, nerol, nonanol, octanol, para-menthan-7-ol, phenylethyl alcohol, phenol, phenyl salicylate, tetrahydrogeraniol, tetrahydrolinalool, thymol, trans-2-cis-6-nonadicnol, trans-2-nonen-1-ol, trans-2-octenol, undecanol, vanillin, cinnamyl alcohol.

The completely transesterified oligosilicic acid esters are particularly preferred in various embodiments. These are products in which each R¹ to R⁴ represents a fragrance alcohol group. In various embodiments, it is preferred that each of R¹ to R⁴ is selected independently of one another from the group consisting of the residues of the following fragrance alcohols: 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol, 4-tert-butylcyclohexanol, 6,8-dimethyl-2-nonanol, 6-nonen-1-ol, 9-Decen-1-ol, alpha methyl benzyl alcohol, alpha terpineol, amyl salicylate, benzyl alcohol, benzyl salicylate, beta terpineol, butyl salicylate, citronellol, cyclohexyl salicylate, decanol, dihydromyrcenol, dimethyl benzyl carbinol, dimethyl heptanol, dimethyl octanol, ethyl salicylate, ethylvanillin, eugenol, geraniol, heptanol, hexyl salicylate, isoborneol, isoeugenol, isopulegol, linalool, menthol, myrtenol, n-hexanol, nerol, nonanol, octanol, para-menthan-7-ol, phenylethyl alcohol, phenol, phenyl salicylate, tetrahydrogeraniol, tetrahydrolinalool, thymol, trans-2-cis-6-nonadicnol, trans-2-nonen-1-ol, trans-2-octenol, undecanol, vanillin, cinnamyl alcohol.

Also suitable in the context of the present invention are silicic acid ester mixtures containing, in addition to or instead of the silicic acid esters of formula (I) described above, silicic acid esters of formula (V)

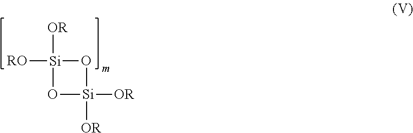

wherein all R are selected independently of one another from the group containing H, the straight-chain or branched, saturated or unsaturated, substituted or unsubstituted C₁₋₆ hydrocarbongroups and the fragrance alcohol groups, and m takes values from the range of 1 to 20 and n takes values from the range of 2 to 100.

The compounds of formula (V) can be prepared analogously by simple transesterification of oligosilicic acid esters of lower alcohols with fragrance alcohols, wherein it is possible to use individual perfumes or fragrance alcohol mixtures. Depending on the reaction time and reaction conditions, the lower alcohols are cleaved off and the fragrance alcohols are bound, with the alcohols being more easily exchanged along Si—O—Si chains or rings than the terminal alcohols. Such transesterifications can be carried out, for example, as described in the publication H. Steinman, G. Tschernko, H. Hamann, Z. Chem. 3, 1977, pp. 89-92. The content of this publication is expressly regarded as the disclosure of this application with regard to the preparation of silicic acid esters. Commercially available silicic acid esters are usually used as starting materials. The ethanol ester, which can be obtained, for example, from Wacker, Burghausen, should be mentioned here in particular. The transesterification can be controlled exclusively by increasing the temperature and distilling off the volatile by-products. However, it is preferable if catalysts are used for the transesterification. These are usually Lewis acids, preferably aluminum tetraisopropylate, titanium tetraisopropylate, silicon tetrachloride or basic catalysts or also preparations such as, for example, aluminum oxide with potassium fluoride. The oligomeric silicic acid esters formed in this way then have at least some fragrance alcohol groups. However, the resulting esters usually also contain groups of lower alcohols. If small amounts of water or other H-acidic compounds are present in the preparation of the silicic acid esters, alcohol groups are also exchanged for OH groups. Accordingly, in the context of the present invention, suitable silicic acid ester mixtures usually also partially contain hydrogen as group R.

Silicic acid rings can frequently also be formed during the esterification as a result of side reactions, as indicated in formula (V). In particular rings which contain 3 or 4 silicon atoms are preferably formed. Accordingly, in particular silicic acid ester mixtures which contain the silicic acid esters of formulas

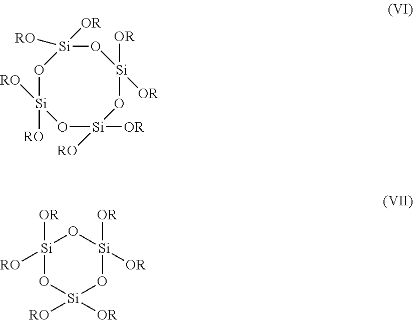

are preferred.

The degrees of oligomerization “n” of suitable silicic acid esters are between 2 and 20. In preferred compounds, n takes values between 2 and 15, preferably between 2 and 12 and in particular between 3 and 10, with the values 4, 5, 6, 7 and 8 being particularly preferred. Particularly preferred oligosilicic acid esters can therefore be described by formulas VIII, IX, X, XI and XII:

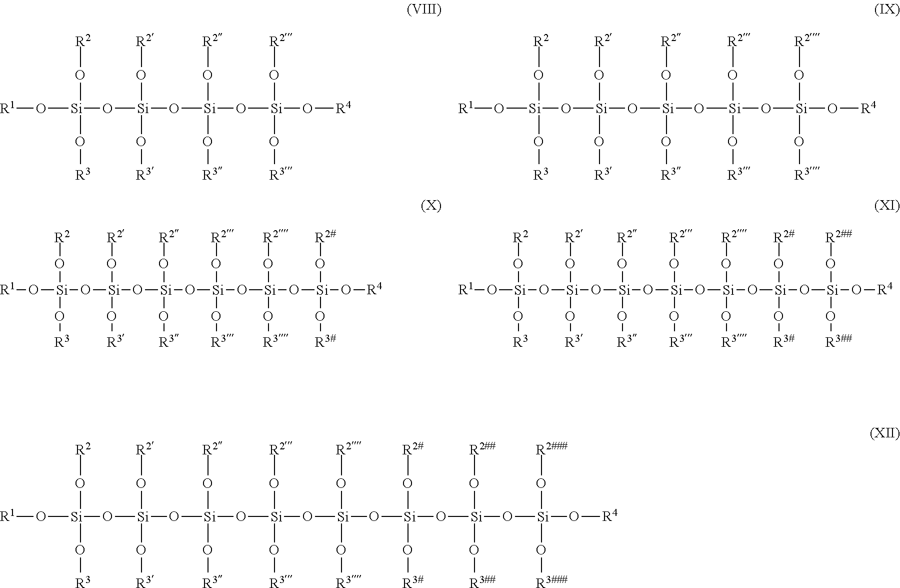

In formulas VIII, IX, X, XI and XII, R², R²′, R²″, R²′″, R²″″, R^{2 #}, R^{2 ##}, R^{2 ###}, R³, R³′, R³″, R³′″, R³″″, R^{3 #}, R^{3 ##}and R^{3 ###}may each be derived from one and the same fragrance alcohol or originate from different fragrance alcohols. In the latter case, mixtures of different fragrance alcohols are used in the transesterification and in this way, depending on the ratios of the fragrance alcohols used, mixed oligosilicic acid esters are obtained in which R², R^{2′}, R²″, R²′″, R²″″, R^{2 #}, R^{2 ##}, R^{2 ###}, R³, R³′, R³″, R³′″, R³″″, R^{3 #}, R^{3 ##}and R^{3 ###}; can be different from one another.

Since the starting compounds for the preparation of the compounds described above are preferably not pure substances for economic reasons, but rather technical mixtures of oligosilicic acid esters of lower alcohols with different degrees of oligomerization, there is also a distribution of the degrees of oligomerization in the corresponding esters, which can correspond to the starting material or is modified by the reaction conditions. The compounds given in formulas VIII, IX, X, XI and XII represent individual species which are preferably present in high amounts in technical mixtures of suitable silicic acid esters. According to the invention, however, mixtures of the compounds mentioned and thus fractional degrees of oligomerization can also be used.

Although in principle a wide variety of esters can be prepared, within the scope of the present invention it is preferable to prepare completely transesterified oligosilicic acid esters which are only based on a single fragrance alcohol, i.e. all transesterified R (for example R, R′, R¹, R², etc.) are identical, i.e. originate from the same fragrance alcohol.

In various embodiments, the at least one perfume composition contains the at least one fragrance precursor compound, as defined above, in an amount of from approximately 0.001 to 20 wt. %, preferably in an amount of from approximately 0.01 to approximately 10 wt. %, for example in an amount of approximately 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5 or 10 wt. %, in each case based on the total weight of the perfume composition. In the case of a mixture of different fragrance precursor compounds, the amounts stated above relate to the total quantity of fragrance precursor compounds.

In various embodiments, the proportion of the perfume composition in the total weight of the washing and/or care article according to the invention is approximately 0.001 to approximately 20 wt. %, preferably approximately 0.1 to approximately 10 wt. %, for example approximately 0.1, 0.2, 0.3, 0.4, 0.5, 0.6, 0.7, 0.8, 0.9, 1.0, 1.5, 2.0, 2.5, 3.0, 3.5, 4.0, 4.5, 5.0, 5.5, 6.0, 6.5, 7.0, 7.5, 8.0, 8.5, 9.0, 9.5 or 10 wt. %, in each case based on the total weight of the washing and/or care article.

In the context of the present invention it is preferable that after the preparation of the substrate, the

The article as described herein, which according to the invention comprises at least one perfume composition as defined and described above, is an article which is suitable for use in textile washing and/or care methods. According to the invention, the article described is accordingly a washing and/or care article for textiles, and consequently a textile treatment agent, as defined above.

According to the invention, such an agent comprises, in addition to the at least one perfume composition as defined above, at least one other active substance, preferably at least two other active substances, which further improve the performance and/or aesthetic properties of the agent. These include, for example, in particular surfactants, enzymes, UV stabilizers, dyes, color-capturing compounds, color transfer inhibitors, optical brighteners, preservatives, bittering agents, disinfectants, defoamers, encapsulated ingredients, pH adjusters, leavening agents and additives which improve the feel on the skin or skin care additives.

The amount of correspondingly suitable further constituents depends on the relevant intended use of the agent, and a trained person skilled in the art is generally familiar with suitable dosages of these constituents or is able to find correspondingly suitable quantity information in the literature.

In various embodiments, the carrier substrate of the article according to the invention is accordingly treated with a washing agent composition or fabric conditioning composition. Suitable components of such a composition can be selected, without limitation, from the aforementioned active substance categories. In various embodiments, the at least one leavening agent, as defined and described above, may be a constituent of such a washing agent composition or fabric conditioning composition.

In order to improve washing efficiency, the article may comprise at least one surfactant. Within the meaning of the present invention, a surfactant is a surface-active ingredient which is able to remove dirt particles from the textile(s) during a washing process using the relevant washing agent, due to micelles being formed. Suitable surfactants include cationic, anionic, non-ionic and amphoteric surfactants. Any mixtures of two or more surfactants can also be used, depending on the desired wash performance.

Suitable anionic surfactants include, but are not limited to, alkylbenzene sulfonates, olefin sulfonates, alkane sulfonates, fatty alcohol sulfates, fatty alcohol ether sulfates, or a mixture of two or more of these anionic surfactants. Of these anionic surfactants, alkylbenzene sulfonates, fatty alcohol ether sulfates and mixtures thereof are particularly preferred.

Surfactants of the sulfonate type that can be used are preferably alkylbenzene sulfonates, olefin sulfonates, i.e. mixtures of alkene and hydroxyalkane sulfonates, and disulfonates, as obtained, for example, from C₁₂₋₁₈ monoolefins having a terminal or internal double bond by way of sulfonation with gaseous sulfur trioxide and subsequent alkaline or acid hydrolysis of the sulfonation products. C₁₂₋₁₈ alkane sulfonates and the esters of α-sulfofatty acids (ester sulfonates) are also suitable, for example the α-sulfonated methyl esters of hydrogenated coconut, palm kernel or tallow fatty acids.

Alkylbenzene sulfonates are preferably selected from linear or branched mono- and dialkylbenzene sulfonates. The alkyl groups can contain individually or together 9 to 19, preferably 9 to 15, and in particular 9 to 13, carbon atoms. A very particularly preferred representative is sodium dodecylbenzene sulfonate.

The salts of the sulfuric acid half-esters of C₁₂-C₁₈ fatty alcohols, for example from coconut fatty alcohol, tallow fatty alcohol, lauryl, mirystyl, cetyl or stearyl alcohol or of C₁₀-C₂₀ oxo alcohols and the half-esters of secondary alcohols having these chain lengths are preferred as alk(en)yl sulfates. From a washing perspective, C₁₂-C₁₆ alkyl sulfates, C₁₂-C₁₅ alkyl sulfates and C₁₄-C₁₅ alkyl sulfates are preferred. 2,3-alkyl sulfates are also suitable anionic surfactants.

Alkyl ether sulfates of formula R¹—O—(AO)ₙ—SO₃—X⁺ are also suitable. In this formula, R¹ represents a linear or branched, substituted or unsubstituted alkyl group, preferably a linear, unsubstituted alkyl group, particularly preferably a fatty alcohol group. Preferred R¹ are selected from decyl, undecyl, dodecyl, tridecyl, tetradecyl, pentadecyl, hexadecyl, heptadecyl, octadecyl, nonadecyl and eicosyl groups and mixtures thereof, the representatives having an even number of carbon atoms being preferred. Particularly preferred R¹ are derived from C₁₂-C₁₈ fatty alcohols, for example from coconut fatty alcohol, tallow fatty alcohol, lauryl, myristyl, cetyl or stearyl alcohol, or from C₁₀-C₂₀ oxo alcohols.

AO represents an ethylene oxide (EO) or propylene oxide (PO) group, preferably an ethylene oxide group. The index n represents an integer from 1 to 50, preferably from 1 to 20, and in particular from 2 to 10. Very particularly preferably, n represents the numbers 2, 3, 4, 5, 6, 7 or 8. X represents a monovalent cation or the n-th part of an n-valent cation, the alkali metal ions, including Na⁺ or K⁺, being preferred in this case, with Na⁺ being most preferred. Further cations X⁺ can be selected from NH₄⁺, ½ Zn²⁺, ½ Mg²⁺, ½ Ca²⁻, ½ Mn²⁺ and mixtures thereof.

The anionic surfactants can be present in the form of the sodium, potassium, magnesium or ammonium salts thereof. The anionic surfactants are preferably present in the form of the sodium salts and/or ammonium salts thereof. Amines which can be used for neutralization are preferably choline, triethylamine, monoethanolamine, diethanolamine, triethanolamine, methylethylamine, or a mixture thereof, with monoethanolamine being preferred.

Suitable non-ionic surfactants include alkoxylated fatty alcohols, alkoxylated oxo alcohols, alkoxylated fatty acid alkyl esters, fatty acid amides, alkoxylated fatty acid amides, polyhydroxy fatty acid amides, alkylphenol polyglycol ethers, amine oxides, alkyl (poly)glucosides and mixtures thereof.

Preferred agents contain at least one fatty alcohol alkoxylate of the formula R²—O—(AO)ₘ—H, in which R² represents a linear or branched, substituted or unsubstituted alkyl group, AO represents an ethylene oxide (EO) or propylene oxide (PO) group, and m represents integers from 1 to 50.

In the aforementioned formula, R² represents a linear or branched, substituted or unsubstituted alkyl group, preferably a linear, unsubstituted alkyl group, particularly preferably a fatty alcohol group. Preferred R² are selected from decyl, undecyl, dodecyl, tridecyl, tetradecyl, pentadecyl, hexadecyl, heptadecyl, octadecyl, nonadecyl and eicosyl groups and mixtures thereof, the representatives having an even number of carbon atoms being preferred. Particularly preferred R² are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

AO represents an ethylene oxide (EO) group or propylene oxide (PO) group, preferably an ethylene oxide group. The index m represents an integer from 1 to 50, preferably from 1 to 20, and in particular from 2 to 10. Very particularly preferably, m represents the numbers 2, 3, 4, 5, 6, 7 or 8.

According to a further advantageous development, in order to obtain a particularly good wash performance with a high dirt loosening power, a mass fraction of surfactant is approximately 1 to 50 wt. % and in particular approximately 3 to 25 wt. %, for example approximately 3, 4, 5, 6, 7, 8, 9, 10, 11, 12, 13, 14, 15, 16, 17, 18, 19, 20, 21, 22, 23, 24 or 25 wt. %, based on the total mass of the article. When using a combination of two or more surfactants, the mass fraction refers to the total mass of the surfactants used.

In various embodiments, a washing and/or care article according to the invention contains at least one anionic surfactant, preferably in an amount of approximately 5 to 25 wt. %, more preferably approximately 10 to 15 wt. %, for example approximately 10, 10.5, 11, 11.5, 12, 12.5, 13, 13.5, 14, 14.5 or 15 wt. %, in each case based on the total weight of the washing and/or care article.

In various other embodiments a washing and/or care article according to the invention contains at least one non-ionic surfactant, preferably in an amount of approximately 0.1 to 20 wt. %, more preferably approximately 1 to 10 wt. %, for example approximately 1, 2, 3, 4, 5, 6, 7, 8, 9 or 10 wt. %, in each case based on the total weight of the washing and/or care article.

Furthermore, in some embodiments, the carrier substrate may include a color-capturing compound. For example, the carrier substrate can be coated or impregnated with a color-capturing compound. When the substrate is a textile substrate, the dye scavenger is typically absorbed into or onto the textile carrier material, for example as onto the individual fibers, due to the absorbent properties of the textile material. Color-capturing coatings which are suitable in principle are known in the prior art and are mentioned, for example, in PCT/EP2017/050080, the content of which is fully incorporated herein by reference.

Dye-capturing compounds which are suitable in principle are, for example, polyamines or GMAC (glycidyl trimethyl ammonium chloride), or a precursor of GMAC, such as 3-chloro-2-hydroxypropyl trimethyl ammonium chloride. Specific examples of suitable dye scavenger compounds are GMAC and the precursors thereof.

Other suitable dye scavenger compounds include N-trisubstituted ammonium 2-hydroxy-3-halopropyl compounds of general formula (I):

X′—CH₂—CHOH—CH₂—N⁺(R¹R²R³)Y′⁻ (I)

wherein R¹, R² and R³ each represent, independently of one another, methyl, ethyl, propyl, butyl, benzyl or a hydroxyl-substituted derivative thereof, X′ is a halogen atom and Y′⁻ is chloride, bromide, sulfate or sulfonate, or an epoxy propyl ammonium salt of general formula (II):

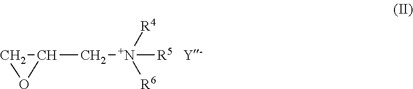

wherein R⁴, R⁵, R⁶ and Y′⁻ have the same meaning as R¹, R², R³ and of the above formula (I), as defined above.

In various embodiments, the dye-capturing compound is a compound of formula (I) or (II), wherein R¹, R², R³ or R⁴, R⁵, R⁶ are each, independently of one another, methyl, ethyl, propyl, butyl, benzyl or a hydroxyl-substituted derivative thereof, preferably methyl, ethyl, n-propyl or n-butyl, more preferably methyl or ethyl, most preferably methyl. X′ is a halogen atom, preferably selected from Cl or Br.

Y′⁻ and/or Y″⁻ are selected from chloride, bromide, sulfate or sulfonate, preferably chloride. It goes without saying that, when Y′ or Y″ is a sulfate anion or sulfonate anion, this refers to a ½ sulfate/sulfonate ion, i.e. the anion is shared by two positively charged ammonium compounds.

In various embodiments, the dye-capturing compound is preferably an epoxidepropylammonium salt of general formula (II), preferably a glycidyltrimethylammonium salt, also known as (2,3-epoxypropyl)trimethylammonium salt, more preferably the chloride salt, which is available in solid form or as a 72% aqueous composition from Sigma Aldrich, wherein R⁴, R⁵ and R⁶ are each methyl and Y″⁻ is chloride.

Alternatively, the compound may be a compound of formula (I) above, for example 3-chloro-2-hydroxypropyltrimethylammonium chloride, available from Sigma Aldrich, wherein R¹, R² and R³ are each methyl, X′ is chlorine and Y′ is chlorine.

Of course, more than one compound of formula (I) or (II) can be used in combination, or a corresponding compound can be used in combination with another dye-capturing compound of formula (I) or (II).

Methods of applying dye-capturing compounds are known in the prior art and may be used accordingly in the context of the present invention.

Suitable builders which can be contained in the agent are in particular silicates, aluminum silicates (in particular zeolites), carbonates, salts of organic di- and polycarboxylic acids, and mixtures of these substances.

Organic builders are, for example, the polycarboxylic acids that can be used in the form of the sodium salts thereof, polycarboxylic acids being understood to mean those carboxylic acids that carry more than one acid function. These include, for example, citric acid, adipic acid, succinic acid, glutaric acid, malic acid, tartaric acid, maleic acid, fumaric acid, saccharic acids, aminocarboxylic acids, and mixtures thereof. Preferred salts are the salts of polycarboxylic acid, citric acid, adipic acid, succinic acid, glutaric acid, tartaric acid, saccharic acids, and mixtures thereof.

Polymeric polycarboxylates are also suitable as builders. These are, for example, the alkali metal salts of polyacrylic acid or of polymethacrylic acid, e.g. those having a relative molecular mass of from 600 to 750,000 g/mol.

In addition, copolymeric polycarboxylates are suitable, in particular those of acrylic acid with methacrylic acid and of acrylic acid or methacrylic acid with maleic acid. In order to improve water solubility, the polymers can also contain allyl sulfonic acids, such as allyloxybenzene sulfonic acid and methallyl sulfonic acid, as monomers.

The enzyme can be any enzyme that is known in the prior art for use in washing and cleaning agents or that will be used in the future. The enzyme may be a hydrolytic enzyme or another enzyme in a concentration that is expedient for the effectiveness of the agent.

All enzymes which can develop catalytic activity in the agent according to the invention, in particular a protease, lipase, amylase, cellulase, hemicellulase, mannanase, tannanase, xylanase, xanthanase, xyloglucanase, β-glucosidase, pectinase, carrageenanase, perhydrolase, oxidase, or oxidoreductase, and mixtures thereof, can preferably be used.

Particularly preferably, the enzymes exhibit synergistic cleaning performance against specific stains or spots, i.e., the enzymes contained in the agent composition support one another in their cleaning performance. Very particularly preferably, there is such synergism between a protease and a further enzyme of an agent according to the invention, including in particular between a protease and an amylase and/or a lipase and/or a mannanase and/or a cellulase and/or a pectinase. Synergistic effects may arise not only between different enzymes, but also between one or more enzymes and other ingredients of the agent according to the invention.

Agents according to the invention in particular have at least one protease and at least one amylase. In a further embodiment of the invention, the agents have at least one protease and at least one cellulase. In a further embodiment, agents have at least one protease and at least one lipase.

Examples of proteases are the subtilisins BPN′ from Bacillus amyloliquefaciens and Carlsberg from Bacillus licheniformis, protease PB92, subtilisins 147 and 309, the protease from Bacillus lentus, subtilisin DY, and the enzymes thermitase, proteinase K and proteases TW3 and TW7, which belong to the subtilases but no longer to the subtilisins in the narrower sense. Subtilisin Carlsberg is available in a developed form under the trade name Alcalase® from Novozymes. Subtilisins 147 and 309 are marketed by Novozymes under the trade names Esperase® and Savinase®, respectively. The protease variants marketed under the name BLAP® are derived from the protease from Bacillus lentus DSM 5483. Other proteases that can be used are, for example, the enzymes available under the trade names Durazym®, Relase®, Everlase®, Nafizym®, Natalase®, Kannase® and Ovozyme® from Novozymes, the enzymes available under the trade names Purafect®, Purafect® OxP, Purafect® Prime, Excellase® and Properase® from Danisco/Genencor, the enzyme available under the trade name Protosol® from Advanced Biochemicals Ltd., the enzyme available under the trade name Wuxi® from Wuxi Snyder Bioproducts Ltd., the enzymes available under the trade names Proleather® and Protease P® from Amano Pharmaceuticals Ltd., and the enzyme available under the name Proteinase K-16 from Kao Corp. The proteases from Bacillus gibsonii and Bacillus pumilus, which are disclosed in international patent applications WO2008086916 and WO2007131656, are particularly preferably used. Further proteases that can advantageously be used are disclosed in patent applications WO9102792, WO2008007319, WO9318140, WO0144452, GB1243784, WO9634946, WO2002029024 and WO2003057246. Further proteases that can be used are those which are naturally present in the microorganisms Stenotrophomonas maltophilia, in particular Stenotrophomonas maltophilia K279a, Bacillus intermedius and Bacillus sphaericus. Protease variants based on the Bacillus lentus DSM 5483 protease (BLAP), such as those with the R99E substitution, are particularly suitable. Such particularly suitable proteases are described, for example, in WO 2016/096714.

Examples of amylases are α-amylases from Bacillus licheniformis, Bacillus amyloliquefaciens or Bacillus stearothermophilus, as well as in particular the developments thereof that have been improved for use in washing or cleaning agents. The enzyme from Bacillus licheniformis is available from Novozymes under the name Termamyl® and from Danisco/Genencor under the name Purastar® ST. Development products of this α-amylase are available from Novozymes under the trade names Duramyl® and Termamyl® ultra, from Danisco/Genencor under the name Purastar® OxAm, and from Daiwa Seiko Inc. as Keistase®. The α-amylase from Bacillus amyloliquefaciens is marketed by Novozymes under the name BAN®, and derived variants from the α-amylase from Bacillus stearothermophilus are marketed under the names BSG® and Novamyl®, also by Novozymes. Furthermore, the α-amylases from Bacillus sp. A 7-7 (DSM 12368) and the cyclodextrin glucanotransferase (CGTase) from Bacillus agaradherens (DSM 9948) should be emphasized for this purpose. Furthermore, the amylolytic enzymes can be used which are disclosed in international patent applications WO2003002711, WO2003054177 and WO2007079938, the disclosure of which is therefore expressly referred to or the disclosure of which is therefore expressly included in the present patent application. Fusion products of all mentioned molecules can also be used. Furthermore, the developments of the α-amylase from Aspergillus niger and A. oryzae, available under the trade name Fungamyl® from Novozymes, are suitable. Other commercial products that can advantageously be used are, for example, Amylase-LT®, and Stainzyme® or Stainzyme Ultra® or Stainzyme Plus®, as well as Amplify™ 12L or Amplify Prime™ 100L, also from Novozymes. Variants of these enzymes that can be obtained by point mutations can also be used according to the invention.

Cellulases (endoglucanases, EG) comprise, for example, the fungal cellulase preparation which is rich in endoglucanase (EG) and the refinements thereof which are provided by Novozymes under the trade name Celluzyme®. The products Endolase® and Carezyme®, also available from Novozymes, are based on 50 kD-EG and 43 kD-EG, respectively, from Humicola insolens DSM 1800. Further commercial products from this company that can be used are Cellusoft®, Renozyme®, and Celluclean®. It is also possible to use cellulases, for example, which are available from AB Enzymes, under the trade names Ecostone® and Biotouch®, and which are, at least in part, based on 20 kD-EG from Melanocarpus. Further cellulases from AB Enzymes are Econase® and Ecopulp®. Further suitable cellulases are from Bacillus sp. CBS 670.93 and CBS 669.93, with the cellulase from Bacillus sp. CBS 670.93 being available from Danisco/Genencor under the trade name Puradax®. Other commercial products that can be used from Danisco/Genencor are “Genencor detergent cellulase L” and IndiAge®Neutra.

Lipases or cutinases can preferably be used, in particular due to the triglyceride-cleaving activities thereof, but also in order to produce peracids in situ from suitable precursors. These include, for example, the lipases that can originally be obtained from Humicola lanuginosa (Thermomyces lanuginosus) or have been developed therefrom, in particular those having one or more of the following amino acid exchanges in positions D96L, T213R and/or N233R, particularly preferably T213R and N233R, proceeding from the mentioned lipase. Lipases are marketed, for example, by the Novozymes company under the trade names Lipolase®, Lipolase® Ultra, LipoPrime®, Lipozyme® and Lipex®. Another lipase that can advantageously be used is available from Novozymes under the trade name Lipoclean®. Moreover, the cutinases which have been originally isolated from Fusarium solani pisi and Humicola insolens can also be used, for example. Lipases that can also be used are available from Amano under the names Lipase CE®, Lipase P®, Lipase B®, and Lipase CES®, Lipase AKG®, Bacillus sp. Lipase®, Lipase AP®, Lipase M-AP® and Lipase AML®. From the Danisco/Genencor, the lipases or cutinases of which the starting enzymes have been isolated originally from Pseudomonas mendocina and Fusarium solanii can be used, for example. The preparations M1 Lipase® and Lipomax® originally marketed by Gist-Brocades (now Danisco/Genencor), the enzymes marketed by Meito Sangyo KK under the names Lipase MY-30®, Lipase OF® and Lipase PL®, and the product Lumafast® from Danisco/Genencor should be mentioned as other important commercial products.

In order to increase the bleaching effect, oxidoreductases such as oxidases, oxygenases, catalases, peroxidases such as halo, chloro, bromo, lignin, glucose, or manganese peroxidases, dioxygenases or laccases (phenoloxidases, polyphenoloxidases) can be used according to the invention. Advantageously, organic, particularly preferably aromatic compounds that interact with the enzymes are additionally added in order to enhance the activity of the relevant oxidoreductases (enhancers) or, in the case of greatly differing redox potentials, to ensure the flow of electrons between the oxidizing enzymes and the contaminants (mediators).

The enzymes to be used in the context of the present invention can originate, for example, from microorganisms, for example of the genera Bacillus, Streptomyces, Humicola or Pseudomonas, and/or can be produced by suitable microorganisms using biotechnological processes which are known per se, for example by transgenic expression hosts, for example of the genera Escherichia, Bacillus, or by filamentous fungi.

It is emphasized that these can be technical enzyme preparations of the relevant enzyme, i.e. accompanying substances can be present. Therefore, the enzymes can be assembled and used together with accompanying substances, for example from fermentation, or with other stabilizers.

In various embodiments, the aforementioned enzymes, i.e. one enzyme or a plurality of enzymes together, can be present in the form of an enzyme formulation which may also contain one or more organic solvents, preferably selected from alcohols, particularly preferably polyhydric alcohols which are liquid under standard conditions (20° C., 1013 mbar), in particular glycerol, 1,2-propanediol and sorbitol, and mixtures thereof, and/or enzyme stabilizers.

In some embodiments, such an enzyme formulation may be present in the form of a slurry, preferably in the form of a pasty slurry. In the context of the present invention, the term “slurry” denotes a liquid, enzyme-containing suspension.

In various embodiments, the pH of the enzyme formulations described above is in the range of 5 to 9.

Enzymes can advantageously be used in amounts of 0.0001 to 5 wt. %, in particular in amounts of 0.001 to 1.5 wt. %, preferably in amounts of 0.01 to 1.0 wt. %, in each case based on the total weight of the washing and/or care article.

The protein concentration can generally be determined using known methods, for example the BCA method (bicinchoninic acid; 2,2′-bichinolyl-4,4′-dicarboxylic acid) or the Biuret method. (A. G. Gornall, C. S. Bardawill and M. M. David, J. Biol. Chem., 177 (1948), pp. 751-766). The active protein concentration can be determined in this regard by titrating the active centers using a suitable irreversible inhibitor and determining the residual activity (cf. M. Bender et al., J. Am. Chem. Soc. 88, 24 (1966), pp. 5890-5913).

It may be desirable to keep the active ingredients that have a positive effect on the feel on the skin or other sensitive active ingredients, such as enzymes, spatially separated from other constituents of the agent until use. An elegant method for incorporating such sensitive, chemically or physically incompatible or volatile ingredients is the use of microcapsules, in which these ingredients are enclosed in a storage-stable and transport-stable manner and from which they are released mechanically, chemically, thermally or enzymatically for or during use.

Microcapsules are finely dispersed liquid or solid phases coated with film-forming polymers, during the production of which the polymers precipitate on the material (active ingredient) to be coated after emulsification and coacervation or interfacial polymerization. In this case, the active ingredient is encased in a shell-like manner by a solid membrane (microcapsule in the narrower sense) or enclosed by a matrix (microsphere or sphere). In the following, the term microcapsule is used in the general sense for both variants. Such capsules are usually microscopically small (<50 μm) and are sometimes also referred to as nanocapsules or nanospheres and they can be dried like powder. However, larger capsules or beads (>0.5 mm) which are visible to the naked eye and filled with active ingredients can also be produced.

All surfactant-stable capsules and capsule materials or spheres and sphere materials available on the market can be used as microcapsules, such as the commercially available Primasphere® (chitosan and agar or carboxymethyl cellulose) and Primasponge® (alginate, chitosan, agar) from BASF, Hallcrest Microcapsules® (gelatine, gum arabic) from Hallcrest, Inc. (US), Coletica Thalaspheres® (maritime collagen) from Coletica (FR), Lipotec Millicapseln® (alginic acid, agar-agar) from Lipotec SA (ES), Induchem Unispheres® (lactose, microcrystalline cellulose, hydroxypropyl methylcellulose) and Unicerin® C30 (lactose, microcrystalline cellulose, hydroxypropyl methylcellulose) from Induchem AG (CH), Kobo Glycospheres (modified starch, fatty acid esters, phospholipids) and Softspheres® (modified agar-agar) from Kobo (US), and Kuhs Probiol Nanospheres (phospholipids) from Kuhs (DE) and others. The microcapsules can have any shape in terms of production, but they are preferably egg-shaped or ellipsoidal or in particular approximately spherical. Depending on the active ingredient and application, the diameter along the greatest spatial extension of the microcapsule can be on average between 100 nm (not visually recognizable as a capsule) and 10 mm. The preferred average diameter is in the range between 0.1 mm and 7 mm, microcapsules with an average diameter between 0.4 mm and 5 mm being particularly preferred. Dyes, color pigments or pearlescent components can also be added to improve the appearance.

The active ingredient can be released from the microcapsules mechanically by crushing the microcapsules during the cleaning method. Other possibilities are releasing the active ingredient by changing the temperature (introduction into warm rinsing liquor), shifting the pH, and changing the electrolyte content, etc.

In general, the pH of an agent can be adjusted using standard pH regulators. In various embodiments, the pH of the agents described herein is in a range from 6.5 to 12, preferably from 7.0 to 11.5, preferably greater than 7, in particular from 7.5 to 10.5. Acids and/or alkalis, preferably alkalis, are used as pH adjusters. Suitable acids are, in particular, organic acids, such as acetic acid, citric acid, glycolic acid, lactic acid, succinic acid, adipic acid, malic acid, tartaric acid and gluconic acid, or sulfamic acid. In addition, however, the mineral acids hydrochloric acid, sulfuric acid and nitric acid or mixtures thereof can also be used. Suitable bases originate from the group of alkali and alkaline-earth metal hydroxides and carbonates, in particular alkali metal hydroxides, of which potassium hydroxide is preferred. The alkali source described above is particularly preferably used to adjust the pH. Even if volatile alkali, for example in the form of ammonia and/or alkanolamines, which can contain up to 9 carbon atoms in the molecule, can be used to adjust the pH, it being possible for the alkanolamine to be selected from the group consisting of mono-, di-, triethanol- and -propanolamine and mixtures thereof, volatile alkali sources of this kind, in particular ethanolamines, are preferably avoided. In various embodiments, agents described herein therefore contain less than 1.75 wt. % of alkanolamine, in particular monoethanolamine, and are very particularly preferably free thereof.

In order to adjust and/or stabilize the pH, an agent can also contain one or more buffer substances (INCI buffering agents), usually in amounts from 0.001 to 5 wt. %. Buffer substances, which are also complexing agents or even chelating agents (chelators, INCI chelating agents), are preferred. Particularly preferred buffer substances are citric acid or citrates, in particular sodium and potassium citrates, for example trisodium citrate.2H₂O and tripotassium citrate.H₂O.

The term “leavening agent,” as used herein, also refers to compounds known in the art as “raising agents”. In principle, all types of such known biological and chemical raising agent compounds are suitable. However, chemical leavening agents are preferred in the context of the present invention. Examples of such compounds include, but are not limited to, carbonates and bicarbonates, in particular carbonates and bicarbonates of alkali metals or alkaline-earth metals, and ammonium (bi)carbonate. Specific examples further include, but are not limited to, sodium carbonate, sodium bicarbonate, ammonium carbonate and potash, and mixtures thereof. It is also possible to use one or more of the aforementioned compounds from the group of carbonates or bicarbonates in combination with an acidifying agent. Suitable acidifying agents include organic and inorganic acidifying agents. Exemplary organic acidifying agents include, but are not limited to, carboxylic acids and polycarboxylic acids such as amino acids, hydroxycarboxylic acids, and hydroxydicarboxylic acids. Specific examples suitable in the context of the present invention include, but are not limited to, citric acid, isocitric acid, lactic acid, tartaric acid, malic acid, mandelic acid, glycolic acid, tartronic acid, mevalonic acid, adipic acid, succinic acid, glutaric acid, maleic acid, fumaric acid, salicylic acid and saccharic acids, optionally in the form of their salts, in particular their alkali metal or alkaline earth metal salts, preferably their sodium, potassium, magnesium or calcium salts. Exemplary inorganic acidifying agents include, but are not limited to, phosphoric acid and its salts, in particular its alkali or alkaline earth salts, preferably its sodium, potassium, magnesium, or calcium salts, such as monocalcium orthophosphate. Organophosphates and condensates of phosphoric acid, such as diphosphoric acid and metaphosphoric acid, and their salts, in particular their alkali metal or alkaline earth metal salts, preferably their sodium, potassium, magnesium or calcium salts, such as disodium hydrogen phosphate, are also suitable. Accordingly, conventional baking powder, which is, for example, a mixture of sodium bicarbonate and an acidifying agent, such as, but not limited to, disodium hydrogen phosphate, monocalcium orthophosphate, citric acid, tartaric acid or potassium tartrate, is in principle also suitable as a leavening agent in the context of the present invention. Sodium bicarbonate, ammonium carbonate, potash and mixtures thereof are preferred in various embodiments.

If present, the leavening agent content can be approximately 0.001 to 10 wt. %, based on the total weight of the washing and/or care article.

An optical brightener is preferably selected from the substance classes of distyrylbiphenyls, stilbenes, 4,4″-diamino-2,2″-stilbene disulfonic acids, cumarines, dihydroquinolones, 1,3-diarylpyrazolines, naphthalic acid imides, benzoxazole systems, benzisoxazole systems, benzimidazole systems, pyrene derivatives substituted with heterocycles, and mixtures thereof.

Particularly preferred suitable optical brighteners include disodium-4,4′-bis-(2-morpholino-4-anilino-s-triazine-6-ylamino)stilbene disulfonate (for example available as Tinopal® DMS from BASF SE), disodium-2,2′-bis-(phenyl-styryl)disulfonate (for example available as Tinopal® CBS from BASF SE), 4,4′-bis[(4-anilino-6-[bis(2-hydroxyethyl)amino]-1,3,5-triazine-2-yl)amino]stilbene-2,2′-disulfonic acid (for example available as Tinopal® UNPA from BASF SE), hexasodium-2,2′-vinylenebis[(3-sulfonato-4,1-phenylene)imino[6-(diethylamino)-1,3,5-triazine-4,2-diyl]imino]]bis-(benzene-1,4-disulfonate) (for example available as Tinopal® SFP from BASF SE), 2,2′-(2,5-thiophendiyl)bis[5-1,1-dimethylethyl)-benzoxazole (for example available as Tinopal® SFP from BASF SE) and/or 2,5-bis(benzoxazol-2-yl)thiophene.

Suitable color transfer inhibitors include polymers and copolymers of cyclic amines such as vinylpyrrolidone and/or vinylimidazole. Polymers suitable as dye transfer inhibitors include polyvinylpyrrolidone (PVP), polyvinylimidazole (PVI), copolymers of vinylpyrrolidone and vinylimidazole (PVP/PVI), polyvinylpyridine-N-oxide, poly-N-carboxymethyl-4-vinylpyridium chloride, polyethylene glycol-modified copolymers of vinylpyrrolidone and vinylimidazole, and mixtures thereof. Particularly preferably, polyvinylpyrrolidone (PVP), polyvinylimidazole (PVI) or copolymers of vinylpyrrolidone and vinylimidazole (PVP/PVI) are used as a dye transfer inhibitor. The polyvinylpyrrolidones (PVP) used preferably have an average molecular weight of from 2,500 to 400,000 and are commercially available from ISP Chemicals as PVP K 15, PVP K 30, PVP K 60 or PVP K 90, or from BASF as Sokalan® HP 50 or Sokalan® HP 53. The copolymers of vinylpyrrolidone and vinylimidazole (PVP/PVI) used preferably have a molecular weight in the range of from 5,000 to 100,000. A PVP/PVI copolymer is commercially available from BASF under the name Sokalan® HP 56, for example. Other dye transfer inhibitors that can be extremely preferably used are polyethylene glycol-modified copolymers of vinylpyrrolidone and vinylimidazole, which are available from BASF under the name Sokalan® HP 66, for example.

Dyes suitable in the context of the present invention are divided into anionic, non-ionic and cationic dyes.

Anionic dyes are known to a person skilled in the art as acid dyes. Corresponding representatives of this dye class are, for example, the Colour Index (abbreviated: C.I.) published by the British Society of Dyers and Colourists and American Association of Textile Chemists and Colorists. The limiting quantity range of the anionic dyes according to the invention thus relates at least to all acid dyes specified in the Colour Index as anionic dyes. The commercial products Basacid Blue V20, Sensient Blue, Tartrazine Acid Yellow 23, Sunset Yellow E110, Iragon Blue ABL80, Sanolin Violet E2R and Vibracolor violet AVI 43 are listed as examples.

Nonionic dyes which are suitable according to the invention are selected from at least one non-ionic azo dye. Exemplary non-ionic dyes include, but are not limited to, Liquitint® Violet 200, Liquitint® Violet CT, Liquitint® Blue HP, Liquitint® Cyan 15, and Liquitint® Brilliant Orange (each from Milliken).

The basic dyes (according to the Colour Index: basic dyes) are preferably suitable cationic dyes. Cationic dyes which are particularly preferably suitable according to the invention are selected from at least one dye from the group formed from cationic azo dye, xanthene dye, phenazine dye, phenoxazine dye, thiazine dye, polymethine dye, diarylcarbenium dye and triarylmethane dye. The dyes methylene blue, rhodamine b, Vibracolor Citrus Yellow and crystal violet may be mentioned here as examples

In some embodiments, the textile washing and/or care articles described herein, as described above, are preferably prepackaged to form dosing units. These dosing units preferably comprise the amount of washing-active or care-active substances necessary for a textile treatment cycle. In preferred embodiments, the article is in the form of a unit dosage.

The weight of a sheet according to the invention in a unit dosage is typically in the range of 0.1-90 g, preferably in the range of 1-10 g.

Typical formulations of sheets according to the invention in ready-to-use form are compiled below:

| Ingredients | Widest range [wt. %] | Preferred range [wt. %] |
|---|---|---|
| Surfactants | 10-90 | 25-70 |
| PVA | 1-80 | 10-30 |
| Starch | 1-80 | 10-50 |
| Solvent | 0-15 | 0.3-10 |
| Preservatives | 0-10 | 0.1-5 |
| Accompanying substances | 0.01-20 | 0.1-10 |
| mineral oil | 0.01-20 | 0.1-5 |
| Polyethyleneimine | 0.01-40 | 0.1-30 |
| Enzymes (mannase, | 0.0001-10 | 0.001-5 |
| xanthanase, licheninase) | | |
| Perfume | 0.01-20 | 0.1-5 |
| Water | 0-10 | 0-5 |

The use of the washing and/or care article according to the invention, as described above, for washing, cleaning and/or care purposes, in particular for textile washing and/or care purposes, as defined herein, is a further aspect of the invention. The present invention relates in particular to such uses in which a washing and/or care article as described herein is used in manual washing, cleaning and/or care applications.

A further subject of the invention is a method for washing, caring for or conditioning textiles, characterized in that a washing and/or care article as described herein is used in at least one method step. The present invention relates to both manual and automatic washing and cleaning methods. However, manual methods are also preferred here, since the advantageous “blooming effect” of the article according to the invention can be particularly noticeable and appealing in this case.

An article as described herein can in principle also be used advantageously in combination with other textile washing and/or care agents in corresponding methods, such as in combination with a washing agent and/or a textile conditioning agent.

All aspects, objects and embodiments described for articles according to the invention are also applicable to this subject matter of the invention. Therefore, reference is expressly made at this point to the disclosure at the appropriate point with the note that this disclosure also applies to the above-described uses and methods according to the invention.

### EXAMPLES

### Example 1: Product Manufacturing and Performance

### Preparation:

The components were mixed as pre-solutions and then, in a conventional method, placed a heated, rotating roller to form a sheet structure. The correspondingly obtained and finally dried structure was finally cut to obtain sheets of common use dimensions.

### Performance:

Sheets (E1) according to the invention were compared with comparable products (V1 and V2) with regard to their inherent scent and scenting properties. The segments “wash liquor odor”, “odor of damp laundry” and “odor of dry laundry” refer to the odor profiles generated during manual washing using the respective sheets.

TABLE 1

| Formulation | Perfume | | | | |
|---|---|---|---|---|---|
| | | Intensity of odor (1 odorless-10 very strong) | | | |
| | | | | Odor of | Odor of |
| | | Inherent product | Wash liquor | damp | dry |
| | | odor | odor | laundry | laundry |
| E1: | 0.8 wt. % of | 7.5 | 7 | 7 | 5 |
| Sheets | perfume | | | | |
| containing | containing | | | | |
| starch and | 1.5 wt. % of | | | | |
| PVA | precursors from | | | | |
| | the group of | | | | |
| | oxazolidines and | | | | |
| | silicic acid esters | | | | |
| V1: | 0.8 wt. % of | 8 | 8.5 | 8 | 6 |
| Sheets | perfume without a | | | | |
| containing | precursor fromthe | | | | |
| starch and | group of | | | | |
| PVA | oxazolidines and | | | | |
| | silicic acid esters | | | | |

| | | Intensity of product odor after storage (1 odorless-10 | | |
|---|---|---|---|---|
| | | very intense) | | |
| | | | 4 weeks at | 4 weeks at |
| | | Fresh | 23° C. | 40° C. |
| E1: | 0.8 wt. % of | 7.5 | 7 | 6.5 |
| Sheets | perfume | | | |
| containing | containing | | | |
| starch and | 1.5 wt. % of | | | |
| PVA | precursors from | | | |
| | the group of | | | |
| | oxazolidines and | | | |
| | silicic acid esters | | | |
| V2: | 0.8 wt. % of | 7.5 | 6 | 5 |
| Sheets | perfume | | | |
| without | containing | | | |
| starch and | 1.5 wt. % of | | | |
| PVA | precursors from | | | |
| | the group of | | | |
| | oxazolidines and | | | |
| | silicic acid esters | | | |

1. A washing and/or care article for textiles, wherein the article comprises:
a substrate comprising polyvinyl alcohol and starch; and
one or more perfume compositions comprising one or more free fragrances and one or more fragrance precursor compounds.

2. The article according to claim 1, wherein the substrate is water-soluble.

3. The article according to claim 1, wherein the substrate further comprises one or more water-soluble polymer selected from the group consisting of polyamide, polylactide, protein, alginate, chitosan, galactan, gum Arabic, derivatives thereof, and copolymers thereof.

4. The article according to claim 1, wherein the substrate comprises polyvinyl alcohol in an amount ranging from approximately 1 to 80 wt. % in each case based on the total weight of the substrate.

5. The article according to claim 1, wherein the substrate comprises starch in an amount ranging from approximately 1 to 80 wt. % in each case based on the total weight of the substrate.

6. The article according to claim 1, wherein the one or more fragrance precursor compounds is selected from the group consisting of oxazolidine compounds and silicic acid esters.

7. The article according to claim 1, wherein the one or more fragrance precursor compounds is selected from:
i) a 1-aza-3,7-dioxabicyclo[3.3.0]octane compound of formula (I): 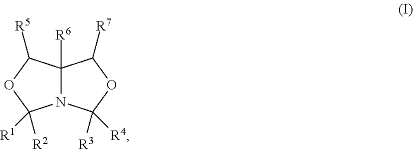
wherein:
R¹ and R³ each represent, independently of one another, hydrogen or a group having 1 to 10 carbon atoms; and
R² and R⁴ each represent, independently of one another, groups having 1 to 25 carbon atoms; and
R⁵ and R⁷ each represent, independently of one another, hydrogen or a group having 1 to 6 carbon atoms; and
R⁶ represents hydrogen or a group having 1 to 8 carbon atoms,
wherein:
one or more methyl groups, methylene groups, methine groups or quaternary carbon atoms of R¹ to R⁷ is each substituted, independently of one another, with heteroatoms; and
at least one of the structural fragments —CR¹R²— or —CR³R⁴— of general formula (I) originates from a fragrance aldehyde or fragrance ketone; and
if one of the structural fragments —CR¹R²— or —CR³R⁴— originates from a fragrance ketone, R¹ and R² or R³ and R⁴ of this structural fragment are wholly or partially an integral component of a ring; or
ii) a silicic acid ester compound of formula (IV): 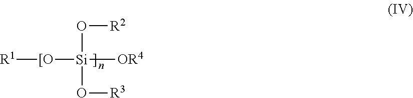
wherein:
R¹ and R⁴ are selected independently of one another from the group consisting of straight-chain or branched, saturated or unsaturated, substituted or unsubstituted C₁₋₆-hydrocarbon groups and fragrance alcohol groups,
each R² and R³ is selected, independently of one another, from the group consisting of fragrance alcohol groups, and
n ranges from 2 to 20; or
iii) a mixture of a silicic acid ester compound of formula (IV) and a silicic acid ester compound of formula (V): 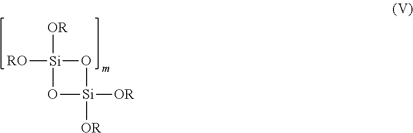
wherein R¹ and R⁴, R² and R³ and n are as defined according to formula (IV).

8. The article according to claim 1, wherein the one or more perfume compositions comprises the one or more fragrance precursor compounds in an amount of approximately 0.001 to 20 wt. % in each case based on the total weight of the one or more perfume compositions.

9. The article according to claim 1, wherein the proportion of the one or more perfume compositions ranges from approximately 0.001 to approximately 20 wt. % in each case based on the total weight of the washing and/or care article.

10. The article according to claim 1, further comprising one or more further active substances selected from the group consisting of surfactants, enzymes, UV stabilizers, dyes, color-capturing compounds, color transfer inhibitors, optical brighteners, preservatives, bittering agents, disinfectants, defoamers, encapsulated ingredients, pH adjusters, leavening agents, and additives, wherein the one or more further active substances improve the feel on the skin and/or are skin care additives.

11. The article according to claim 10, further comprising one or more surfactants, wherein:
the surfactant is an anionic surfactant in each case based on the total weight of the washing and/or care article;
the surfactant is a non-ionic surfactant in each case based on the total weight of the washing and/or care article, and
combinations thereof.

12. The article according to claim 1, wherein the substrate is a planar substrate.

13. A method for washing, caring for, or conditioning textiles, wherein the method comprises:
applying the article according to claim 1 to a textile.

14. The method according to claim 13, wherein the applying occurs during a manual washing of the textile.

15. The article according to claim 4, wherein the substrate comprises polyvinyl alcohol in an amount ranging from approximately 10 to 30 wt. % in each case based on the total weight of the substrate.

16. The article according to claim 5, wherein the substrate comprises starch in an amount ranging from approximately 10 to 50 wt. % in each case based on the total weight of the substrate.

17. The article according to claim 8, wherein the one or more perfume compositions comprises the one or more fragrance precursor compounds in an amount ranging from approximately 0.01 to approximately 10 wt. % in each case based on the total weight of the one or more perfume compositions.

18. The article according to claim 9, wherein the proportion of the one or more perfume compositions in the total weight of the washing and/or care article ranges from approximately 0.1 to approximately 10 wt. % in each case based on the total weight of the washing and/or care article.
